(19) United States
(12) Patent Application Publication
(10) Pub. No.: US 2002/0102883 A1
(43) Pub. Date: Aug. 1, 2002

(54) Card connector and elastic contact piece

(75) Inventors: Seiichirou Mithuhashi, Noda-shi (JP); Seiji Shishikura, Chiba-shi (JP)

Correspondence Address: Finnegan, Henderson, Farabow,, Garrett & Dunner, L.L.P., 1300 I Street, N.W., Washington, DC, 20005-3315, US

(73) Assignee: YAMAICHI ELECTRONICS CO., LTD.

(21) Appl. No.: 10/057,944

(22) Filed: Jan. 29, 2002

(30) Foreign Application Priority Data
Jan. 31, 2001 (JP) 2001-024424

(51) Int. Cl. H01R 24/00

(52) U.S. Cl. 439/630

(57) ABSTRACT

A card connector has a plurality of contact terminals, each of which comprises a fixed portion securely fixed in a connector housing and a spring portion having a contact portion at an end thereof opposite the fixed portion and extending from the fixed portion to be elastically displaceable. A card having a plurality of contact pads formed thereon is accommodated and held in the connector housing in such a way that the plurality of contact pads engage the associated contact portions of the plurality of contact terminals arranged in the connector housing. A cross section of the spring portion is changed along its length by changing its width or thickness so that a mass of a part of the spring portion of each contact terminal near the fixed portion is larger than a mass of a part of the spring portion near the contact portion.

This application is based on application No. 2001-024424 filed Jan. 31, 2001 in Japan, the content of which is incorporated hereinto by reference.

### BACKGROUND OF THE INVENTION

1. Field of the Invention

The present invention relates to a card connector mounted on electronic devices, such as cellular phones, telephones, PDAs (personal digital assistants), portable audio devices and cameras, and an elastic contact piece built into the card connector, and more particularly to improvements of these for improving their impact resistance and for providing a contact structure with no electrical short breaks.

2. Description of the Related Art

In electronic devices such as cellular phones, telephones, PDAs and cameras, a variety of functions are added by inserting an IC card with a built-in memory and even a control circuit, such as a SIM (subscriber identity module) card, an MMC (multimedia card), a Smart Media (tradename), an SD (super density; or secure digital) card and a Memory Stick (tradename).

The card connector for removably accommodating such an IC card has a plurality of contact terminals formed from metal leaf springs in a connector housing which are brought into contact with a plurality of contact pads formed on a front or back surface of the inserted IC card to electrically connect the IC card to the electronic device on which the connector is mounted. The contact pads of the IC card include a power supply pad connected to a power supply line and a plurality of signal pads for transferring a variety of signals. These pads are connected through the contact terminals of the card connector to the associated power supply circuit and a variety of signal processing circuits of the electronic device.

When an electronic device having such a card connector loaded with a card should fall applying impacts or vibrations to the connector, the contact pads of the inserted card may part from the contact terminals of the connector depending on the magnitude of the impacts, causing a so-called short break in which electrical conduction is interrupted momentarily, and in an extreme case the card may get out of the connector.

If such an accident occurs while data is being written from the electronic device into the card, the data being written may be lost or data stored in the card damaged, or in the worst case the memory card itself may fail.

FIG. 6 shows an example of a conventional contact terminal 60 incorporated in such a card connector.

The contact terminal 60 is supported in a connector housing like a cantilever and has a terminal portion 61 soldered to a contact pad or the like of a printed circuit board, a fixed portion 62 securely press-fitted in the connector housing, and an elastically displaceable spring portion 63. The spring portion 63 is bent a predetermined angle to the fixed portion 62 and has a contact portion 64 at its front end side. The contact portion 64 is curved upwardly convex for engagement with the contact pad of the card.

In this conventional contact terminal 60, the spring portion 63 between the fixed portion 62 and the contact portion 64 has almost constant thickness and width over its entire length. Hence, the mass distribution of the spring portion 63 of the conventional contact terminal is almost uniform and therefore the center of gravity a of the spring portion 63 including the contact portion 64 is located near the contact portion 64.

When such a conventional contact terminal is applied an impact as a result of fall of an electronic device, an impact force or inertial force at time of impact acts on the spring portion 63 uniformly over the entire length. In other words, the impact force acts on the center of gravity a near the contact portion 64. Therefore, when the conventional contact terminal is subjected to impacts or vibrations, the spring portion 63 can easily be elastically displaced or deformed, resulting in a momentary electrical break between the contact pads of the card and the contact portions of the contact terminals. The conventional contact terminals, as described above, have a problem of low impact resistance or low vibration resistance.

It is conceivable to increase the impact resistance of the card by setting large the contact pressure of the contact portion making up the contact terminal. This method, however, also increases the operation force required to insert or withdraw the card at the same rate and thus degrades the operability of the card in terms of card insertion and withdrawal.

### SUMMARY OF THE INVENTION

The present invention has been accomplished under these circumstances and it is an object of the invention to provide a card connector which has improved impact and vibration resistances of the contact terminals to enhance the capability of the connector to hold a card at time of impact.

Another object of the invention is to provide an elastic contact piece with improved impact and vibration resistances which can remain engaged with a mating object at all times even when subjected to impacts or vibrations.

According to one aspect of the present invention, there is provided a card connector having a plurality of contact terminals, each of the contact terminals comprising: a fixed portion securely fixed in a connector housing and a spring portion having a contact portion at an end thereof opposite the fixed portion and extending from the fixed portion to be elastically displaceable; wherein a card having a plurality of contact pads formed thereon is accommodated and held in the connector housing in such a way that the plurality of contact pads contact the associated contact portions of the plurality of contact terminals arranged in the connector housing; wherein a mass of a part of the spring portion of each contact terminal near the fixed portion is set larger than a mass of a part of the spring portion near the contact portion as by changing a cross section of the spring portion along its length.

A means for realizing the above includes:

(1) increasing the cross section of the spring portion of each contact terminal from the contact portion side toward the fixed portion side,

(2) increasing the width of the spring portion from the contact portion side toward the fixed portion side, and

(3) increasing the thickness of the spring portion from the contact portion side toward the fixed portion side.

With this invention, since the mass of a part of the spring portion of each contact terminal near the fixed portion is set larger than that of the spring portion near the contact portion, the center of gravity is located closer to the fixed portion than in the conventional contact terminal. Thus, the impact force or inertial force distribution in the spring portion when subjected to impacts is such that its magnitude in the spring portion is larger on the fixed portion side than on the contact portion side. The impact force acting on the center of gravity therefore is closer to the fixed portion than in the conventional contact terminal. This makes the contact portion in contact with the contact pad of the card less easily displaceable or deformable at time of impact, thus more reliably preventing a momentary electrical interruption when subjected to impacts or vibrations.

According to another aspect of the present invention, there is provided an elastic contact piece comprising: a fixed portion for supporting the contact piece like a cantilever; and a spring portion having a contact portion at an end thereof opposite the fixed portion and extending from the fixed portion to be elastically displaceable; wherein the elastic contact piece has its contact portion pressed under pressure against a mating object; wherein a mass of a part of the spring portion of each contact piece near the fixed portion is set larger than a mass of a part of the spring portion near the contact portion.

In addition to the contact terminals for signal and power supply connection, the elastic contact piece can also be used for a variety of kinds of switches, such as a switch for detecting the position of a write protect button on a card and a card recognition switch for detecting the presence or absence of a card in the connector, and also for a braking piece for applying a braking force to the card to prevent it from jumping out of the connector during the card ejection operation or a card locking mechanism for preventing the card from slipping off.

In the elastic contact piece of this invention, because the center of gravity of the spring portion is shifted toward the fixed portion, the contact portion of the elastic contact piece is made less easily displaced or deformed. This prevents more reliably the contact portion in contact under pressure with a mating object from disengaging from it due to impacts or vibrations.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a perspective view showing an example of an IC card to be inserted into a card connector of the present invention;

FIG. 2 is a perspective view showing an outline construction of an embodiment of the card connector of the invention;

FIG. 3 is a perspective view showing a first embodiment of a contact terminal used in the card connector of the invention;

FIG. 4 is a perspective view showing a second embodiment of the contact terminal used in the card connector of the invention;

FIG. 5 is a horizontal cross section showing an example of a write protect detection switch; and

FIG. 6 is a perspective view showing a conventional contact terminal.

### DETAILED DESCRIPTION OF PREFERRED EMBODIMENTS

Now, embodiments of this invention will be described in detail by referring to the accompanying drawings.

In the following embodiments, descriptions concern a case where this invention is applied to a connector for a double-height card called an SD card.

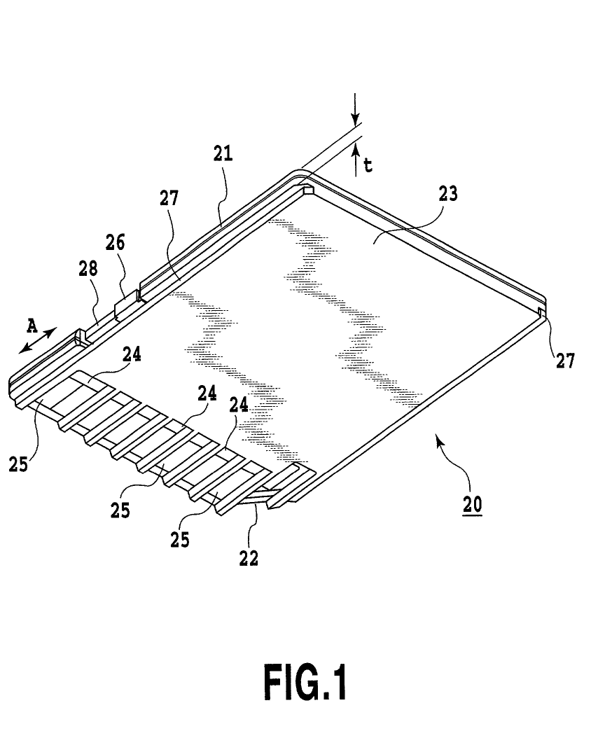

FIG. 1 shows an SD card 20 as an IC card (memory card) as seen from the bottom or back side thereof. The SD card 20 has an upper body portion 21 with a thickness t and a lower body portion 23 slightly narrower in width than the upper body portion 21. That is, the card 20 has stepped portions 27 formed along both side edges. The upper body portion 21 has a triangular cut-off corner portion 22 at one front corner to prevent erroneous insertion.

The lower body portion 23 has a plurality of recessed portions 24 in its front area, in each of which a contact pad 25 is arranged. The contact pads 25 have a 9-pin structure including a power supply pin and signal pins for data, command, clock and others.

A side surface of the card 20 is formed with a notch (recess) 28 in which a write protect button 26 is slidably arranged in card insertion/withdrawal directions (directions of arrow A). The write protect button 26 can assume two positions, a write disable position and a write enable position and is slidable between these two positions.

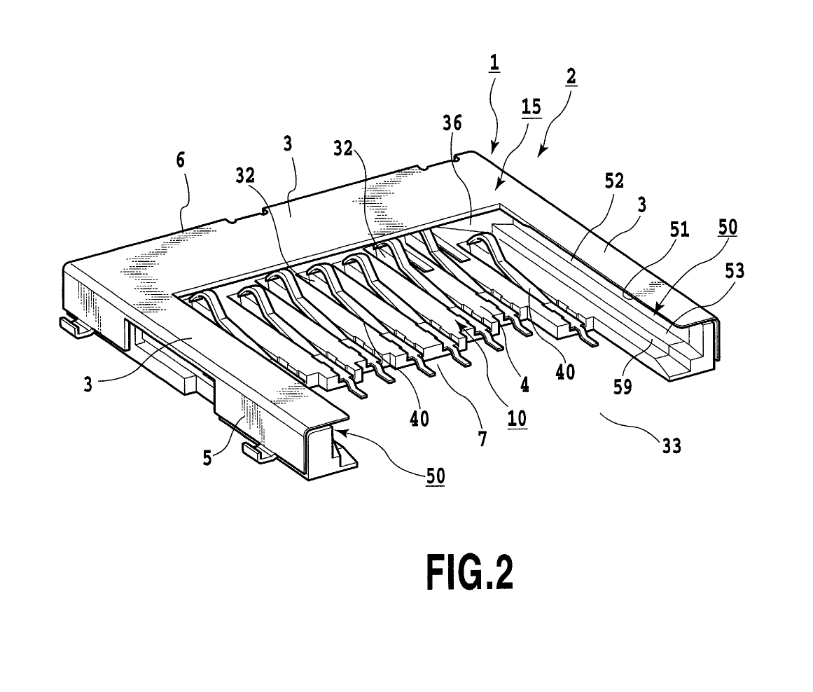

FIG. 2 is a perspective view showing an embodiment of a card connector 1 into which the card 20 described above is to be loaded.

This card connector 1 is mounted on electronic devices such as cellular phones, PDAs, portable audio devices, small portable game machines and cameras, and the card 20 is inserted into the connector 1 with the contact pad surface facing down.

The connector housing 2 comprises a housing body 10 molded from an insulating material such as resin and a cover 15 shaped or molded from a metal or resin. The connector housing 2 has a top portion 3, a bottom plate portion 4, side portions 5 and a rear portion 6, all these portions being combined to form a card accommodating portion 7. The card 20 is inserted from a card insertion opening 33 formed at the front of the housing 2.

The left and right side portions 5 are each formed with a guide groove 50, and the card is inserted or retracted along the guide grooves 50 with the contact pad surface of the card facing down. Each of the guide grooves 50 has an upper wall 51, a side wall 52 and a lower wall 53. From the edge of the lower wall of each guide groove 50 a side wall 59 extends downwardly. In this example, the upper walls 51 of the guide grooves 50 are formed by the cover 15.

In the housing 2 is formed an abutment wall (not shown) against which the front end of the inserted IC card 20 is abutted. At one corner of the abutment wall is formed a protruding corner wall 36 which engages the cut-off corner portion 22 of the IC card 20.

The bottom plate portion 4 of the housing is formed with a plurality of press-fit grooves 32 in which a plurality (in this example, nine) of contact terminals 40 are positioned and press-fitted.

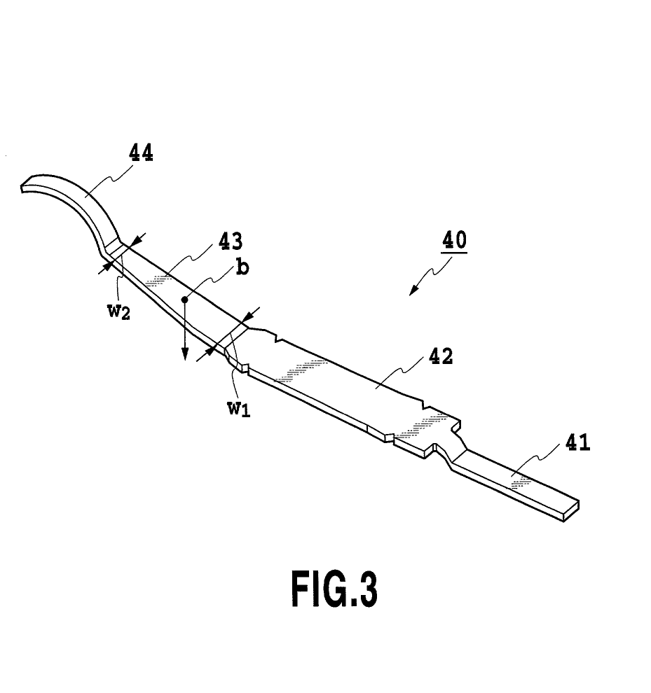

FIG. 3 is an enlarged view of a first embodiment of the contact terminal 40 to be securely press-fitted in the press-fit groove 32.

As shown in FIG. 3, each of the contact terminals 40 is formed from a metal cantilevered leaf spring piece and has a terminal portion 41 to be soldered to the contact pad of a printed circuit board in an electronic device, a fixed portion 42 to be securely fixed into the press-fit groove 32, and an elastically displaceable spring portion 43. The spring portion 43 is bent a predetermined angle relative to the fixed portion 42 and has on its front end side a contact portion 44 that is curved upwardly convex for engagement with the contact pad 25 of the card 20. These contact terminals 40 are pushed under pressure into the press-fit grooves 32 from the front side of the connector housing 2 where they are securely held.

In the contact terminal 40 of FIG. 3, the spring portion 43 between the contact portion 44 and the fixed portion 42 progressively increases in width toward its base (on the side of the fixed portion 42). If the width of the base of the spring portion 43 is taken as W1 and the width of the front as W2, the ratio of W1/W2 is preferably equal to or more than 2.

While the contact terminal of FIG. 3 has the width of the fixed portion 42 set almost equal to the width W1 of the base of the spring portion 43, it may be set wider or narrower than the width W1 of the base.

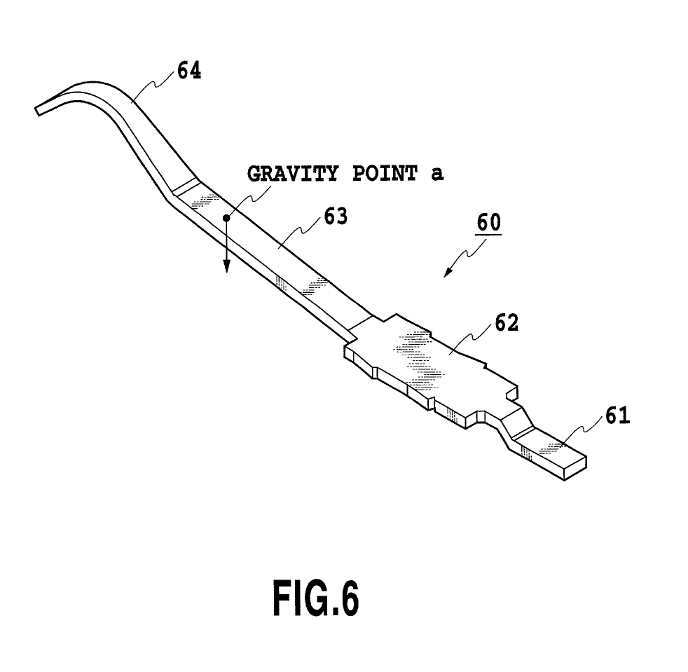

In the contact terminal 40 shown in FIG. 3, because the width of the spring portion 43 is made to increase toward its base (on the side of the fixed portion 42), the center of gravity b of the spring portion 43 including the contact portion 44 is closer to the base (on the fixed portion 42) than in the conventional contact terminal of FIG. 6. Thus, with this contact terminal 40, when an impact is applied to the connector, the impact force acting on the center of gravity b is closer to the base (on the fixed portion 42 side) than in the conventional contact terminal. In other words, an impact force distribution or inertial force distribution in the spring portion 43 at time of impact is such that its magnitude increases toward the fixed portion 42 side. Therefore, the spring portion 43 of the contact terminal 40 is less easily displaced or deformed elastically than the conventional one, thereby reliably preventing a momentary electrical break between the contact pads 25 of the card 20 and the contact portions 44 of the contact terminals 40 when subjected to impacts or vibrations.

Although in the contact terminal of FIG. 3 the width of the spring portion 43 is gradually increased toward the fixed portion 42, the shape of the spring portion 43 may be arbitrary as long as the width WI of the spring portion 43 on the side of the fixed portion 42 is set larger than the width W2 on the contact portion 44 side (front end side) and the center of gravity is located closer to the fixed portion 42 than in the conventional contact terminal. For example, the spring portion 43 may set roughly a half thereof on the front end side to have a constant narrow width and a remaining half on the base side to have a constant wide width.

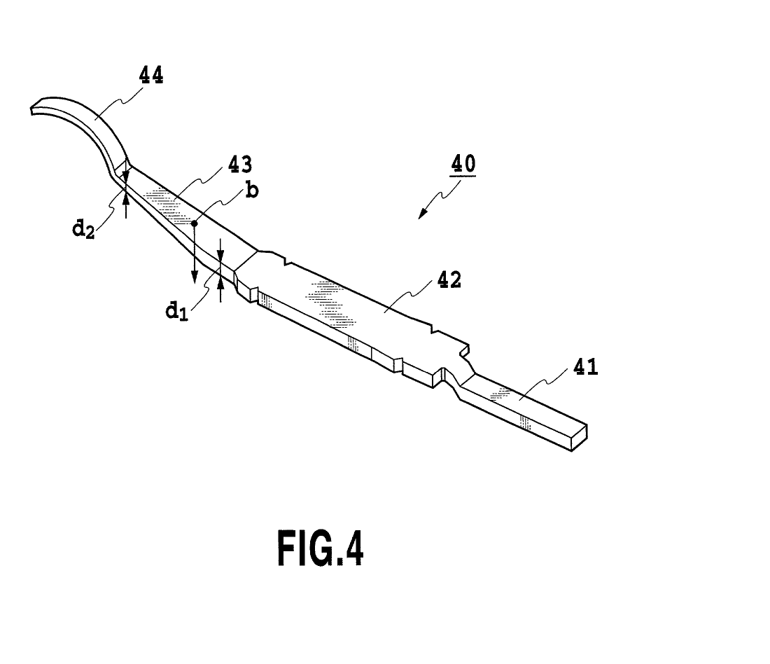

FIG. 4 shows a second embodiment of the contact terminal.

In the contact terminal 40 of the second embodiment, the thickness of the spring portion 43 between the contact portion 44 and the fixed portion 42 gradually increases toward the base (on the fixed portion 42 side). If the thickness of the base is d1 and the thickness of the front end d2, the ratio d1/d2 is preferably equal to or larger than 3/2.

While in the case of FIG. 4 the thicknesses of the fixed portion 42 and the terminal portion 41 are set almost equal to the thickness d1 of the base of the spring portion 43, these portions may be set to arbitrary thicknesses and may be larger or smaller than the thickness of the base d1.

In the contact terminal of the second embodiment, because the thickness of the spring portion 43 is set to increase toward the base (on fixed portion 42 side), the center of gravity b of the spring portion 43 including the contact portion 44 is located closer to the base (on the fixed portion 42 side) than in the conventional contact terminal shown in FIG. 6. Hence, with this contact terminal 40 of FIG. 4, when the connector is subjected to an impact, the impact force acting on the center of gravity b is closer to the base, as in the contact terminal of FIG. 3. Hence, the spring portion 43 of the contact terminal 40 is less easily displaced or deformed elastically than the conventional one, thereby reliably preventing a momentary electrical break between the contact pads 25 of the card 20 and the contact portions 44 of the contact terminals 40 when subjected to impacts or vibrations.

Although in the case of FIG. 4 the thickness of the spring portion 43 is progressively increased toward the fixed portion 42 side, the spring portion 43 may be formed in an arbitrary shape as long as the thickness d1 of the spring portion 43 on the side of the fixed portion 42 is set larger than the thickness d2 on the side of the contact portion 44 (front end side) and the center of gravity is located closer to the fixed portion 42 side than in the conventional contact terminal. For example, the spring portion 43 may have roughly a half thereof on the front end side formed in a constant small thickness and a remaining half on the base side formed in a constant large thickness so that the spring portion 43 has a stepped portion.

In the contact terminal 40 shown in FIG. 3 and FIG. 4, since the width or thickness of the spring portion 43 is increased toward the fixed portion 42, the cross section of the spring portion 43 is made to increase toward the fixed portion 42, which in turn increases the cross-sectional mass of the spring portion 43 as it approaches the fixed portion 42.

It is also possible to set a part of the spring portion 43 near the fixed portion 42 larger in mass than a part of the spring portion 43 near the contact portion 44. For example, by using different materials or different plating materials for these two parts of the spring portion 43, the masses of the two parts of the spring portion 43, one near the fixed portion 42 and the other near the contact portion 44, may be differentiated.

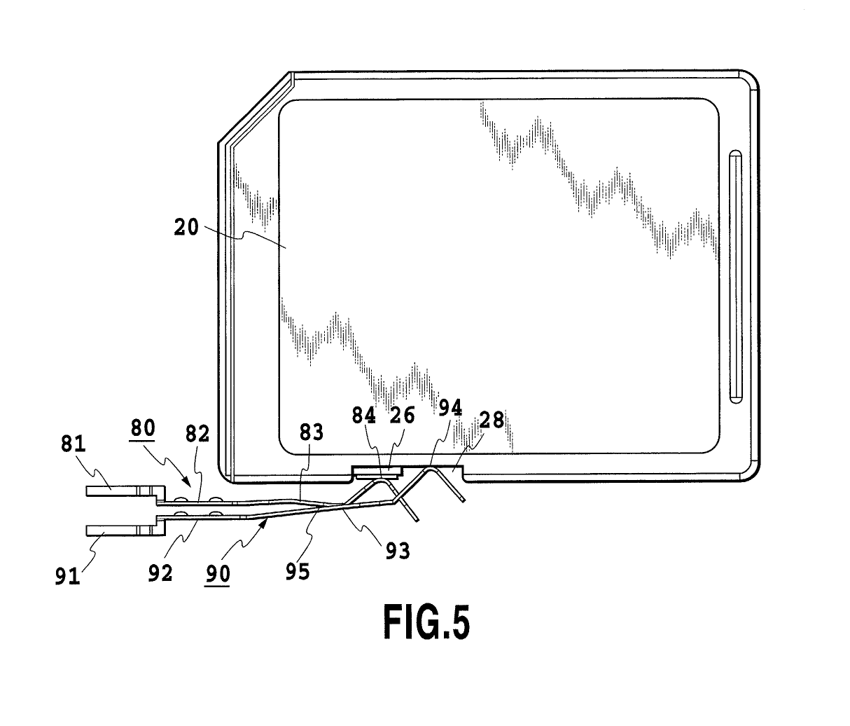

Next, FIG. 5 shows a write protect detection switch SW arranged inside the side portion 5 of the connector housing 2 of FIG. 2.

This switch SW comprises two cantilevered contact leaf springs 80, 90 whose contact portions to be brought into contact with the card 20 are staggered. The engagement and disengagement between these two contact leaf springs 80, 90 can detect the position of the write protect button 26.

The contact leaf spring 80 has a terminal portion 81 securely soldered to a printed circuit board of an electronic device, a fixed portion 82 rigidly fixed in the connector housing 2, a spring portion 83, and a contact portion 84 engaged with the side portion of the card 20.

The contact leaf spring 90 is similarly made from a metal piece having a terminal portion 91, a fixed portion 92, a spring portion 93 and a contact portion 94. The spring portion 93 is formed with a contact projection 95 that contacts the contact leaf spring 80.

The front end portion of the contact leaf spring 80 is bent downwardly of the connector so that it does not interfere with the other contact leaf spring 90.

When the write protect button 26 of the card 20 is situated at a position shown in FIG. 5, the two contact leaf springs 80, 90 are in contact with each other through the contact projection 95 of the contact leaf spring 90 and the switch SW is in a turn-on state. When the write protect button 26 is slid to the other position, the contact leaf springs 80, 90 are parted from each other, turning the switch SW off.

In this switch structure, because the two contact leaf springs 80, 90 are brought into or out of contact with each other according to the position of the write protect button 26, this connection and disconnection can be electrically detected to determine in which of the positions the write protect button 26 of the IC card 20 is set, the write disable position or the write enable position.

In these two contact leaf springs 80, 90 making up the write protect detection switch SW, the width or thickness of the spring portion 83, 93 is increased toward the base, as shown in FIG. 3 or FIG. 4, to increase the cross-sectional mass of the spring portion 83, 93 as it approaches the base. Thus, the spring portions 83, 93 of the contact leaf springs 80, 90 are less easily displaced or deformed elastically than the conventional ones, making the switch more resistant to impacts. This can reliably prevent undesired or erroneous detection due to impacts or vibrations.

In addition to the construction consisting of two contact leaf springs, the write protect detection switch may also be constructed of a single contact leaf spring and a fixed piece. The present invention can also be applied to this single contact leaf spring switch.

(Variation)

While in the above embodiments the spring portion 43 is extended in one direction to form an elastic contact piece 40, this invention can also be applied to a folded type contact terminal in which the spring portion 43 is folded.

The elastic contact piece of the present invention may also be applied to a card recognition switch that detects the presence or absence of a card in the connector, to a braking piece that applies a braking force to the card to prevent the card from jumping out of the connector when ejected, or to a card locking piece that prevents the card from slipping off.

Further, while the embodiments above have been described to use an SD card as the IC card 20, this invention may also be applied to card connectors for IC cards such as SIM card, MMC card, Smart Media (tradename) and Memory Stick (tradename). The structures of the card connectors for these cards may be determined appropriately according to the cards used.

As described above, with the card-connector of this invention, because the mass of a part of the spring portion on the side of the fixed portion of the contact terminal is set larger than the mass of a part of the spring portion on the side of the contact portion, the center of gravity of the spring portion is located closer to the fixed portion than in the conventional contact terminal. This arrangement makes the contact terminal difficult to elastically displace or deform, thus more reliably preventing a momentary electrical break between the contact terminals and the contact pads of the card when applied impacts or vibrations.

Further, with the elastic contact piece of the present invention, because the center of gravity of the spring portion is located closer to the fixed portion than in the conventional contact piece, it is possible to more reliably prevent the contact portion from parting from the mating object when subjected to impacts or vibrations.

The present invention has been described in detail with respect to preferred embodiments, and it will now be that changes and modifications may be made without departing from the invention in its broader aspects, and it is the intention, therefore, in the appended claims to cover all such changes and modifications as fall within the true spirit of the invention.

What is claimed is:

1. A card connector having a plurality of contact terminals, each of the contact terminals comprising:
a fixed portion securely fixed in a connector housing and
a spring portion having a contact portion at an end thereof opposite the fixed portion and extending from the fixed portion to be elastically displaceable;
wherein a card having a plurality of contact pads formed thereon is accommodated and held in the connector housing in such a way that the plurality of contact pads contact the associated contact portions of the plurality of contact terminals arranged in the connector housing; and
wherein a mass of a part of the spring portion of each contact terminal near the fixed portion is set larger than a mass of a part of the spring portion near the contact portion.

2. A card connector as claimed in claim 1, wherein a cross section of the spring portion of each contact terminal near the fixed portion is set larger than a cross section of the spring portion near the contact portion.

3. A card connector as claimed in claim 2, wherein the cross section of the spring portion of each contact terminal is increased from the contact portion side toward the fixed portion side.

4. A card connector as claimed in claim 3, wherein a width of the spring portion of each contact terminal is increased from the contact portion side toward the fixed portion side.

5. A card connector as claimed in claim 3, wherein a thickness of the spring portion of each contact terminal is increased from the contact portion side toward the fixed portion side.

6. An elastic contact piece comprising:
a fixed portion for supporting the contact piece like a cantilever; and
a spring portion having a contact portion at an end thereof opposite the fixed portion and extending from the fixed portion to be elastically displaceable;
wherein the elastic contact piece has its contact portion pressed under pressure against a mating object;
wherein a mass of a part of the spring portion of each contact piece near the fixed portion is set larger than a mass of a part of the spring portion near the contact portion.

7. An elastic contact piece to claim 6, wherein a cross section of the spring portion of each contact piece near the fixed portion is set larger than a cross section of the spring portion near the contact portion.

8. An elastic contact piece as claimed in claim 7, wherein the cross section of the spring portion of each contact piece is increased from the contact portion side toward the fixed portion side.

9. An elastic contact piece as claimed in claim 8, wherein a width of the spring portion of each contact piece is increased from the contact portion side toward the fixed portion side.

10. An elastic contact piece as claimed in claim 8, wherein a thickness of the spring portion of each contact piece is increased from the contact portion side toward the fixed portion side.
